(19) United States
(12) Patent Application Publication
(10) Pub. No.: US 2024/0191872 A1
(43) Pub. Date: Jun. 13, 2024

(54) COMBUSTION SYSTEM USING, AS AN OXIDIZER, A MIXTURE OF MOLECULAR OXYGEN AND A DEHUMIDIFIED GAS OBTAINED FROM COMBUSTION FUMES

(71) Applicant: CARBODOWN, NOMAIN (FR)

(72) Inventor: Jaouad Zemmouri, Nomain (FR)

(21) Appl. No.: 18/554,096

(22) PCT Filed: Apr. 4, 2022
(86) PCT No.: PCT/EP2022/058847

§ 371 Date: Oct. 5, 2023

(30) Foreign Application Priority Data
Apr. 7, 2021 (FR) FR2103568

(51) Int. Cl. F23C 9/08; F23J 15/06; F23J 15/08; F23L 7/00; F23N 5/26

(52) U.S. Cl. CPC F23C 9/08; F23J 15/06; F23J 15/08; F23L 7/007; F23N 5/265; F23C 2202/30; F23N 2225/26

(57) ABSTRACT

A combustion system including a unit for producing oxidizing gas, a combustion apparatus, a unit for condensing the combustion fumes by bringing the combustion fumes into contact with at least one coolant liquid, a recycler, and a unit for providing molecular oxygen. The unit for producing oxidizing gas makes it possible to supply the combustion apparatus with an oxidizing gas originating from the mixing of molecular oxygen and the recycled portion of the dehumidified gas. The combustion system also includes a regulating unit having the function of automatically regulating the temperature of the coolant liquid of the condensing unit and/or a heater for heating the recycled portion of the dehumidified gas.

### CROSS-REFERENCE TO RELATED APPLICATIONS

This application is a Section 371 National Stage Application of International Application No. PCT/EP2022/058847, filed Apr. 4, 2022, which is incorporated by reference in its entirety and published as WO 2022/214421 A1 on Oct. 13, 2022, not in English.

### TECHNICAL FIELD

The present disclosure relates to the field of combustion of a fuel by means of an oxidizer from a mixture of molecular oxygen (O₂) and a dehumidified gas obtained from combustion fumes.

### PRIOR ART

Conventional combustion consists in mixing air (an oxidizer) in a combustion apparatus (a furnace, boiler, etc.) with a fuel under high-temperature conditions to create oxidation. The reaction is exothermic and is naturally sustained. The air contains 18% molecular oxygen (O₂) and the volume of air used is controlled so that the amount of molecular oxygen is sufficient for combustion.

In conventional combustion, the combustion fumes are mainly composed of molecular nitrogen (N₂), water vapor (H₂O) and carbon dioxide (CO₂). If it is desired to capture the CO₂ from these fumes, it is easy to remove the water vapor by condensing these combustion fumes and collecting the water in liquid form. On the other hand, the main difficulty lies in separating the nitrogen and carbon dioxide. Furthermore, in conventional combustion, depending on the type of fuel used, the combustion fumes may also comprise other polluting gases, in a greater or lesser amount, such as, for example, SOx (sulfur oxides), NOx (nitrogen oxides), HCl (hydrogen chloride), HF (hydrogen fluoride), etc. Consequently, if it is desired to capture the CO₂ from these fumes, it is also necessary to separate the CO₂ from these other pollutants.

Several solutions have been envisaged to capture the CO₂ from fumes from conventional combustion, but their cost remains very high.

In order to reduce the emission of pollutants in combustion fumes, it is known to replace the above-mentioned conventional combustion with combustion, referred to as “oxycombustion”, in which the air (the oxidizer) is replaced with pure molecular oxygen in stoichiometric proportions, the number of oxygen atoms being equal to what is necessary to oxidize all the atoms of the fuel.

The production of molecular oxygen to implement oxycombustion may for example be obtained in a known manner by cryogenics or by electrolysis of water.

In the case for example of oxycombustion of methane (CH₄), combustion fumes are produced consisting of ⅓ CO₂ and ⅔ water by volume. In the case of other fuels, there will also be the pollutants resulting from combustion, such as HCl, SOx, etc. If the fuel does not contain nitrogen, advantageously the fumes will naturally not contain NOx.

The equation of the chemical reaction of the oxycombustion of methane (CH₄) is as follows:

CH₄+2O₂→CO₂+2H₂O−891 KJ/mole of CH₄

This means that each mole of CH₄ will outwardly produce an energy of 891 kJ.

For other fuels, the reactions are analogous, with the appearance of other compounds if the fuel contains atoms other than carbon and hydrogen.

In the case for example of oxycombustion of methane, it is notably easier to capture the CO₂. To that end, it is sufficient to condense the water of the fumes via a cooling or drying process to obtain CO₂ in the gaseous state.

It is therefore currently known to use condensers for condensing the oxycombustion fumes in order to facilitate the capture of CO₂.

A significant difficulty in oxycombustion lies however in the difficulty of controlling combustion, since, unlike in conventional combustion, the oxycombustion temperature can rapidly and uncontrollably become very high in the combustion chamber, to such a degree that conventional combustion apparatuses cannot withstand.

To overcome this difficulty, oxycombustion has already been improved by recycling at least a portion of the combustion fumes comprising CO₂ by mixing them with pure molecular oxygen so as to obtain an oxidizing gas (O₂—CO₂) which advantageously reduces the combustion temperature.

This improvement allows for a more easily controlled molecular-oxygen-based combustion, compared to oxycombustion which uses only pure molecular oxygen as an oxidizer, while reducing the emission of pollutants compared to conventional combustion and facilitating the capture of CO₂.

With this solution of recycling a portion of the combustion fumes, given that the combustion fumes necessarily contain water vapor (H₂O), it is necessary to introduce a wet oxidizing gas into the combustion apparatus, the water content of which can be too high and/or is uncontrolled, which is detrimental to the reliability and proper functioning of the combustion apparatus and may further cause detrimental corrosion of the combustion apparatus over time.

In addition, when the fuel used produces combustion fumes comprising pollutants such as, for example, SOx (sulfur oxides), NOx (nitrogen oxides), HCl (hydrogen chloride), HF (hydrogen fluoride), etc., recycling a portion of the combustion fumes results in a detrimental increase in the concentration over time of the pollutants in the combustion fumes and is therefore not an option. The aforementioned solution of recycling a portion of the combustion fumes is therefore in practice considered only with combustion fumes consisting solely of carbon dioxide and water and devoid of pollutants, such as combustion fumes obtained by combustion of a saturated hydrocarbon of the alkane type (methane, propane, etc.) with molecular oxygen.

### SUMMARY

The subject matter of an exemplary aspect of the present disclosure relates to a combustion system comprising a unit for producing oxidizing gas, a combustion apparatus allowing for combustion of a fuel by means of said oxidizing gas, a condensing unit suitable for condensing the combustion fumes produced by the combustion apparatus, by bringing the combustion fumes into contact with at least one coolant liquid, so as to produce a dehumidified gas, that is to say a gas having an absolute humidity lower than that of the combustion fumes at the inlet of the condensing unit, recycling means, which make it possible to supply the oxidizing gas production unit with at least one recycled portion of the dehumidified gas at the outlet of the condensing unit, a unit for providing molecular oxygen, which makes it possible to supply molecular oxygen to the oxidizing gas production unit. The oxidizing gas production unit makes it possible to supply the combustion apparatus with an oxidizing gas originating from the mixing of molecular oxygen and the recycled portion of said dehumidified gas. The combustion system also comprises a regulating unit, which has the function of automatically regulating the temperature of the coolant liquid of the condensing unit.

The combustion system also has the following technical features (a) and/or (b):
(a) it also comprises at least one sensor making it possible to measure the absolute or relative humidity in the recycled portion (GDR) of the dehumidified gas and/or at least one sensor making it possible to measure the absolute or relative humidity in the oxidizing gas (GC) and/or at least one sensor making it possible to measure the absolute or relative humidity in the combustion fumes and said regulating unit has the function of automatically regulating the temperature of the coolant liquid of the condensing unit based at least on the absolute or relative humidity measured by said sensor in the recycled portion (GDR) of the dehumidified gas and/or based at least on the absolute or relative humidity measured in the oxidizing gas (GC) by said sensor and/or based at least on the absolute or relative humidity measured in the combustion fumes by said sensor;
and/or
(b) the combustion apparatus is characterized by an operating range defining a maximum absolute or relative humidity and a minimum absolute or relative humidity, and the regulating unit has the function of automatically regulating the temperature of the coolant liquid of the condensing unit so as to keep the absolute or relative humidity of the oxidizing gas (GC) within said operating range of the combustion apparatus.

The automatic regulation of the temperature of the coolant liquid of the condensing unit advantageously makes it possible to control the absolute humidity in the recycled portion of the dehumidified gas before it is introduced into the oxidizing gas production unit. Heating the recycled portion of said dehumidified gas makes it possible to increase the temperature of the recycled portion of the dehumidified gas before it is introduced into the oxidizing gas production unit, and thus to advantageously move this temperature of the recycled portion of said dehumidified gas away from its dew point.

More particularly, the combustion system of an aspect of the disclosure can comprise the following additional and optional features, taken in isolation, or in combination with one another:
The regulating unit has the function of automatically regulating the temperature of the coolant liquid of the condensing unit so as to keep the absolute or relative humidity of the recycled portion of the dehumidified gas GD within a predefined operating range.
The regulating unit has the function of automatically regulating the temperature of the coolant liquid of the condensing unit so as to keep the absolute or relative humidity of the oxidizing gas within a predefined operating range.
The regulating unit has the function of automatically regulating the temperature of the coolant liquid of the condensing unit so as to keep the absolute or relative humidity of the combustion fumes within a predefined operating range.
The regulating unit has the function of automatically regulating the temperature of the coolant liquid of the condensing unit so as to keep the temperature of the coolant liquid of the condensing unit at a predefined temperature or within a predefined temperature range.
The combustion system comprises a heating means is suitable for heating the recycled portion of said dehumidified gas, preferably by means of calories taken from the combustion fumes.
The heating means is suitable for heating the recycled portion (GDR) of said dehumidified gas, such that the temperature of the oxidizing gas at the inlet of the combustion apparatus is within a predefined temperature range and/or such that the temperature of the oxidizing gas at the inlet of the combustion apparatus is above the dew point of the oxidizing gas.
The condensing unit comprises at least one condensing device comprising a bath of coolant liquid, and injection means making it possible to move the combustion fumes through this bath of coolant liquid, and preferably wherein the injection means make it possible to inject the combustion fumes below the surface (S) of this bath of coolant liquid.
The combustion system comprises a supply device suitable for introducing one or more treatment additives into the coolant liquid, in order to treat the pollutant(s) potentially captured in the coolant liquid.
The combustion system comprises at least one sensor measuring the pH of the coolant liquid or measuring the concentration of at least one pollutant in the coolant liquid, and a supply device suitable for automatically introducing one or more treatment additives into the coolant liquid, depending on the measured pH or the measured concentration.
Said at least one treatment additive is a base, and more particularly NaOH, KOH, Ca(OH)₂, or is an acid and more particularly sulfuric acid, or is hydrogen peroxide, or is a flocculating agent.
The combustion system comprises a pollution-removing unit (which is positioned between the condensing unit and the recycling point of the recycled portion of the dehumidified gas, and which has the function of removing at least some of the pollutant(s) contained in the dehumidified gas obtained at the outlet of the condensing unit, so as to recycle, as far as the inlet of the oxidizing gas production unit, a recycled portion of dehumidified gas that has had at least some of its pollution removed.
The combustion system comprises a pollution-removing unit which is positioned between the combustion apparatus and the condensing unit, and which has the function of removing at least some of the pollutant(s) contained in the combustion fumes, before they pass through the condensing unit, so as to introduce the combustion fumes into the inlet of the condensing unit with at least some of their pollution removed.
The pollution-removing unit is suitable for capturing one or more pollutants selected from the following list: fine particles, SOx, NOx, acids, heavy metals, ammonia, VOCs.
The pollution-removing unit comprises at least one washing device suitable for bringing the dehumidified gas that is to have pollution removed or the combustion fumes that are to have pollution removed into contact with a washing liquid.
The washing device comprises a bath of washing liquid, and injection means making it possible to move the dehumidified gas that is to have pollution removed or the combustion fumes that are to have pollution removed through this bath of washing liquid, and preferably wherein injection means make it possible to inject the dehumidified gas that is to have pollution removed or the combustion fumes that are to have pollution removed below the surface of this bath of washing liquid.
The combustion system comprises a unit for capturing carbon dioxide (CO₂) from the non-recycled portion of the dehumidified gas.

An aspect of the disclosure also relates to a method for combustion of a fuel by means of the above-mentioned combustion system, wherein the combustion unit is supplied with the fuel and with an oxidizing gas originating from the mixing of molecular oxygen (O₂) and a recycled portion of a dehumidified gas obtained from the combustion fumes.

More particularly, the combustion system of an aspect of the disclosure can comprise the following additional and optional features, taken in isolation, or in combination with one another:
The temperature of the coolant liquid is automatically regulated.
The recycled portion of the dehumidified gas is heated before it is introduced into the oxidizing gas production unit.
Calories are taken from the combustion fumes and are used to heat the recycled portion of the dehumidified gas before it is introduced into the oxidizing gas production unit.
The recycled portion of said dehumidified gas is heated such that the temperature of the oxidizing gas at the inlet of the combustion apparatus is within a predefined temperature range and/or such that the temperature of the oxidizing gas at the inlet of the combustion apparatus (1) is above the dew point of the oxidizing gas.
The fuel is chosen so as to produce, at the outlet of the combustion apparatus, combustion fumes which comprise, and preferably consist of, carbon dioxide (CO₂), water vapor, and optionally molecular oxygen.
The fuel is a hydrocarbon, and preferably a saturated hydrocarbon of the alkane type (CₙH₂ₙ₊₂).
The combustion fumes produced at the outlet of the combustion apparatus comprise carbon dioxide (CO₂), water vapor, optionally molecular oxygen, and one or more pollutants, and more particularly one or more pollutants selected from the following list: fine particles, SOx, NOx, acids, heavy metals, ammonia, VOCs.
The combustion fumes have all or some of their pollution removed as they pass through the condensing unit.
The combustion fumes have all or some of their pollution removed before they pass through the condensing unit.
The dehumidified gas has all or some of its pollution removed before a portion of this dehumidified gas is recycled at the inlet of the oxidizing gas production unit.
Carbon dioxide (CO₂) is captured from the non-recycled portion of the dehumidified gas.

### BRIEF DESCRIPTION OF THE FIGURES

The features and advantages of aspects of the disclosure will become more clearly apparent on reading the detailed description below of several particular alternative embodiments, those particular alternative embodiments being described by way of non-limiting and non-exhaustive examples of the disclosure, and with reference to the appended drawings, in which:

FIG. 1 is a schematic representation of a first particular alternative embodiment of a combustion apparatus of the disclosure;

FIG. 2 schematically shows a particular alternative embodiment of an exchanger that can be used in the condensing unit of the combustion system of FIG. 1;

FIG. 3 schematically shows a second particular alternative embodiment of a combustion apparatus of the disclosure implementing recycling of a portion of the combustion fumes before condensation;

FIG. 4 is a schematic representation of a third particular alternative embodiment of a combustion apparatus of the disclosure, implementing the removal of pollution from the combustion fumes as they pass through the condensing unit;

FIG. 5 is a schematic representation of a fourth particular alternative embodiment of a combustion apparatus of the disclosure, using a unit for removing pollution from the dehumidified gas at the outlet of the condensing unit and before said dehumidified gas is recycled toward the oxidizing gas production unit;

FIG. 6 is a schematic representation of a fifth particular alternative embodiment of a combustion apparatus of the disclosure, implementing the removal of pollution from the combustion fumes before they are introduced into the condensing unit;

FIG. 7 schematically shows a particular alternative embodiment of a washing device that can be used in the pollution-removing unit of the combustion system of FIG. 5 or FIG. 6;

FIG. 8 is a schematic representation of a sixth particular alternative embodiment of a combustion apparatus of the disclosure using a heat recuperator to remove some of the calories in the combustion fumes and to use these calories to heat the recycled portion of the dehumidified gas.

### DETAILED DESCRIPTION

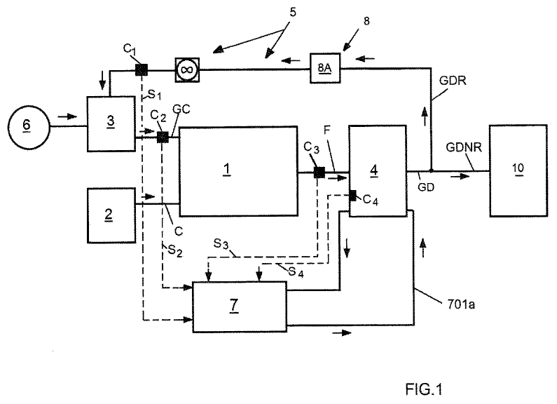

FIG. 1 schematically shows a first alternative embodiment of a combustion system of the disclosure comprising:
a combustion apparatus 1, which in operation is supplied with fuel C by supply means 2;
a unit 3 for producing an oxidizing gas GC, which makes it possible in operation to supply the combustion apparatus 1 with an oxidizing gas GC;
a condensing unit 4, which is suitable for condensing the combustion fumes F produced by the combustion apparatus 1;
recycling means 5, which make it possible to supply the oxidizing gas production unit 3 with at least one recycled portion GDR of the dehumidified gas GD obtained at the outlet of the condensing unit 4,
a unit 6 for providing molecular oxygen, which supplies molecular oxygen to the oxidizing gas production unit 3,
a regulating unit 7.

The production unit 3 in operation makes it possible to produce an oxidizing gas GC originating from the mixing of pure molecular oxygen (O₂), provided by the unit 6, with the recycled portion GDR of said dehumidified gas GD obtained at the outlet of the condensing unit 4.

The unit 6 for providing molecular oxygen may be of any known type and may for example be a unit for producing molecular oxygen by cryogenics and/or a unit for producing molecular oxygen by electrolysis of water. The unit 6 for providing molecular oxygen may also not be designed to produce molecular oxygen in situ but may simply comprise a means for storing molecular oxygen that has been produced beforehand at another site.

The combustion apparatus 1 generally allows for oxycombustion of the fuel C by means of said oxidizing gas GC in a combustion chamber, the thermal energy resulting from this combustion being able to be used interchangeably according to aspects of the disclosure in any type of application requiring a heat supply, and for example in a non-limiting manner to heat a fluid in a heating facility (not shown). This combustion apparatus may equally well be a boiler, a furnace, etc. according to the disclosure.

The recycling at the inlet of the production unit 3 of the recycled portion GDR of the dehumidified gas GD obtained at the outlet of the condensing unit 4 makes it possible, in a manner known per se, to better control the oxycombustion reaction in the combustion apparatus 3 and to significantly lower the combustion temperature in the combustion apparatus 1, compared to an oxycombustion reaction carried out solely from pure molecular oxygen as an oxidizer.

In the context of the disclosure, the fuel C may be very different from one application to the next and may, depending on the case, be in solid, liquid or gaseous form.

The combustion reaction of the fuel C by means of the oxidizing gas GC produces combustion fumes F whose composition depends on the fuel used.

The particular alternative embodiment of FIG. 1 is more particularly suitable for operating with a fuel C producing combustion fumes F which consist of carbon dioxide (CO₂) and water (H₂O) in the form of water vapor, and optionally molecular oxygen and which are devoid of pollutants, for example pollutants of the SOx, NOx or acid type.

Thus, in a non-limiting and non-exhaustive manner, the fuel C used in the combustion system of FIG. 1 may for example be a hydrocarbon of any type, and for example a conventional hydrocarbon derived from oil or natural gas, or an unconventional hydrocarbon derived from shale gas or oil, bituminous shales or sands, coal gas, biogas, sinegas, etc.

For example, when the fuel C is a saturated hydrocarbon of the alkane type (CₙH₂ₙ₊₂), the combustion reaction in the apparatus is in a known manner:

CₙH₂ₙ₊₂+(3n+1)/2O₂→nCO₂+(n+1)H₂O−Energy (KJ/mole of CₙH₂ₙ₊₂)

The condensing unit 4 is suitable for condensing the combustion fumes F produced by the combustion apparatus 1 by bringing these combustion fumes F into contact with a coolant liquid L, so as to produce a dehumidified gas GD having an absolute humidity lower than that of the combustion fumes F at the inlet of the condensing unit 4.

The condensing unit 4 can thus generally comprise any type of exchanger making it possible, by any means, to bring the combustion fumes directly into contact with a coolant liquid L, the temperature of which is lower than that of the combustion fumes, so as to condense at least some of the water contained in the combustion fumes F.

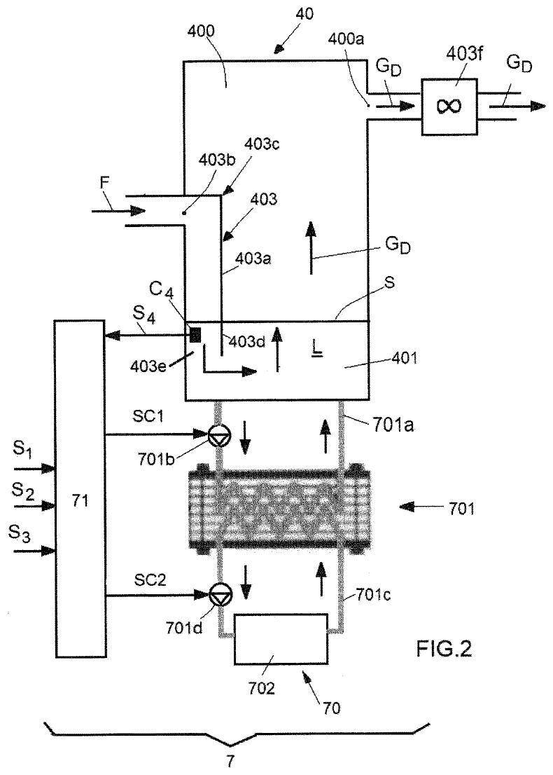

In a preferred alternative embodiment shown in FIG. 2, this exchanger 40 comprises (FIG. 2) an enclosure 400 containing a bath 401 of coolant liquid L and injection means 403, which are suitable for introducing the combustion fumes F below the surface S of the bath of coolant liquid L.

These injection means 403 may more particularly comprise a fan or compressor 403f and a duct 403a comprising an intake opening 403b, for example in its upper part 403c. The lower part 403d of the injection duct 403a is immersed in the bath 401 of coolant liquid L and comprises a discharge opening 403e immersed in the bath 401 of coolant liquid L.

In operation, the fan or compressor 403f makes it possible to suck in the combustion fumes F at the outlet of the combustion apparatus 1 and to introduce them into the injection duct 403 via the inlet opening 403b. These combustion fumes F escape from the injection duct 403 via the discharge opening 403e, and are therefore introduced forcibly into the bath 401 of coolant liquid L, below the surface S of the bath 401 of coolant liquid L, rise to the surface S of the liquid bath, escape from the enclosure 400 via the discharge opening 400a of the enclosure 400 in the form of the above-mentioned dehumidified gas GD

The temperature T_{L} of the coolant liquid L is always less than the temperature T_{F} of the combustion fumes F at the inlet of the exchanger 40 and is preferably less than the dew temperature (dew point) of the combustion fumes.

It is noted that the absolute humidity (g_{water}/kg_{dry air}] of a gas represents the number of grams of water vapor present in a given volume of gas, relative to the mass of dry gas in that volume expressed in kilograms. Its value remains constant even if the temperature of the gas varies, though while remaining greater than the dew point of the gas.

It is also noted that the relative humidity of a gas (expressed in %) is the ratio between the partial pressure of the water vapor and the saturation pressure of the water vapor.

While passing through the bath 401 of coolant liquid L, the combustion fumes F undergo condensation when in contact with the coolant liquid L, so that the absolute humidity of the dehumidified gas GD, at the outlet of the condensing unit 4, is less than the absolute humidity of the combustion fumes F at the inlet of the condensing unit 4.

The difference between the absolute humidity of the dehumidified gas GD and the absolute humidity of the combustion fumes F depends in particular on the difference between the temperature T_{F} of the combustion fumes F and the lower temperature T_{L} of the coolant liquid L. The greater the temperature difference ΔT (ΔT=T_{F}−T_{L}) between the temperature T_{F} of the combustion fumes F and the temperature T_{L} of the coolant liquid L, the lower the absolute humidity of the dehumidified gas GD is compared to the absolute humidity of the combustion fumes F.

On leaving the bath 401 of coolant liquid L, the relative humidity of the dehumidified gas GD will on the other hand be higher, and may in certain operating conditions be close to, or even reach, saturation, that is to say 100% relative humidity.

In another variant, the fan or compressor 403f can be connected to the injection duct 403 and used to introduce the combustion fumes F into this injection duct 403 by blowing them through the intake opening 403b of this injection duct 403.

In another alternative embodiment, the condensing unit 4 may comprise a plurality of exchangers 40 mounted one after another.

The disclosure is not limited to the use of an exchanger 40 of the type shown in FIG. 2. In other alternative embodiments, the exchanger 40 for the condensation of the combustion fumes F may for example be of the type described in international patent application WO 2016/071648 or in international patent application WO 2020/030419 or may be an exchanger operating by spraying the coolant liquid L so that it comes into contact with the combustion fumes F

Regardless of the type of exchanger used for the condensation of combustion fumes by bringing the combustion fumes F into contact with a coolant liquid L, the regulating unit 7 is suitable for automatically regulating the temperature T_{L} of the coolant liquid L of the condensing unit 4.

More particularly, with reference to FIG. 1, to perform this automatic regulation of the temperature of the coolant liquid L, the combustion system preferably comprises at least one of the following humidity sensors:
a sensor C1, which delivers a measurement signal S1 measuring the (absolute or relative) humidity in the recycled portion of the dehumidified gas GDR,
a sensor C2, which delivers a measurement signal S2 measuring the (absolute or relative) humidity in the combustion gas GC introduced into the combustion apparatus 1,
a sensor C3, which delivers a measurement signal S3 measuring the (absolute or relative) humidity in the combustion fumes at the outlet of the combustion apparatus 1.

In this alternative embodiment, the regulating unit 7 is generally designed to automatically regulate the temperature T_{L} of the coolant liquid L of the condensing unit 4 based at least on the (absolute or relative) humidity measured by at least one of the sensors C1, C2 or C3.

In one variant, the regulating unit 7 is designed to automatically regulate the temperature T_{L} of the coolant liquid L of the condensing unit 4 based only on the (absolute or relative) humidity measured by a single sensor among the sensors C1, C2, C3.

In another variant, the regulating unit 7 is designed to automatically adjust the temperature T_{L} of the coolant liquid L of the condensing unit 4 based on each (absolute or relative) humidity measured by at least two sensors among the sensors C1, C2, C3.

In another variant, the regulating unit 7 is designed to automatically adjust the temperature T_{L} of the coolant liquid L of the condensing unit 4 based on the (absolute or relative) humidities measured by the three sensors C1, C2, C3.

This automatic regulation of the temperature of the coolant liquid L by the regulating unit 7 advantageously makes it possible to control and automatically adjust the absolute humidity in the recycled portion GDR of the dehumidified gas GD at the inlet of the unit 3 for producing oxidizing gas GC. By increasing the temperature T_{L} of the coolant liquid L, the absolute humidity is increased in the recycled portion GDR of the dehumidified gas GD. By decreasing the temperature T_{L} of the coolant liquid L, the absolute humidity is decreased in the recycled portion GDR of the dehumidified gas GD.

Using the sensor C1, the automatic regulation of the temperature T_{L} of the coolant liquid L may for example be carried out so as to keep the (absolute or relative) humidity TH of the recycled portion GDR of the dehumidified gas GD at the inlet of the unit 3 for producing oxidizing gas GC within an operating range (THₘᵢₙ; THₘₐₓ) that is predefined (THₘᵢₙ<TH<THₘₐₓ) and compatible with the combustion apparatus 1. This operating range is defined on a case-by-case basis according to the characteristics of the combustion apparatus 1.

Using the sensor C2, the automatic regulation of the temperature T_{L} of the coolant liquid L may for example be carried out so as to keep the (absolute or relative) humidity TH of the oxidizing gas GC at the inlet of the combustion apparatus within an operating range (THₘᵢₙ; THₘₐₓ) that is predefined (THₘᵢₙ<TH<THₘₐₓ) and compatible with the combustion apparatus 1. This operating range is defined on a case-by-case basis according to the operating characteristics of the combustion apparatus 1.

Using the sensor C3, the automatic regulation of the temperature T_{L} of the coolant liquid L may for example be carried out so as to keep the (absolute or relative) humidity TH of the combustion fumes F at the outlet of the combustion apparatus 1 within an operating range (THₘᵢₙ; THₘₐₓ) that is predefined (THₘᵢₙ<TH<THₘₐₓ). This operating range is defined on a case-by-case basis according to the operating characteristics of the combustion apparatus 1.

More particularly, the (absolute or relative) humidity TH of the recycled portion GDR of the dehumidified gas GD at the inlet of the unit 3 for producing oxidizing gas GC has a significant influence on the characteristics of the oxidizing gas GC produced by the production unit 3, and in particular a significant influence on the (absolute or relative) humidity of the oxidizing gas GC and on the dew point of the oxidizing gas GC.

The automatic regulation of the temperature T_{L} of the coolant liquid L is preferably carried out so as to keep the (absolute or relative) humidity of the oxidizing gas GC within an operating range compatible with the combustion apparatus 1, this operating range being able to be provided by the manufacturer of the combustion apparatus 1 or being able to be determined by the user of the combustion apparatus 1.

More particularly, the aforementioned operating ranges (THₘᵢₙ; THₘₐₓ) will be defined on a case-by-case basis to obtain the above-mentioned stability of the (absolute or relative) humidity of the oxidizing gas GC.

With reference to FIG. 1, the combustion apparatus further comprises a heating means 8 advantageously making it possible to heat the recycled portion GDR of the dehumidified gas GD, which makes it possible in operation to raise the temperature of the recycled portion GDR of the dehumidified gas GD before it is introduced into the unit 3 for producing oxidizing gas GC.

This heating means 8 may for example be a heating device 8A supplied by an energy source, such as for example an electrical heater.

This increase in the temperature of the recycled portion GDR of the dehumidified gas GD has the objective of moving the temperature of the recycled portion GDR of the dehumidified gas GD away from its dew point, before it is introduced into the unit 3 for producing oxidizing gas GC, in particular so as to reduce, and preferably avoid, the risks of condensation of the oxidizing gas GC in the combustion apparatus 1 and limit over time the formation of detrimental rust on the walls of the combustion apparatus 1.

It is up to the person skilled in the art to define, on a case-by-case basis, the temperature increase required for the recycled portion GDR of the dehumidified gas GD, in particular so that, for example, the temperature of the oxidizing gas GC at the inlet of the combustion apparatus 1 is within a predefined temperature range, and in particular one recommended for the combustion apparatus 1 and/or so that the temperature of the oxidizing gas GC at the inlet of the combustion apparatus 1 is above the dew point of the oxidizing gas GC.

This heating means 8 is particularly useful when the relative humidity of the recycled portion GDR of the dehumidified gas GD is high, and in practice is useful more particularly when the condensing unit 4 uses a device of the type shown in FIG. 2.

FIG. 2 shows, by way of a non-limiting example of the disclosure, a particular alternative embodiment of the regulating unit 7. In this particular alternative embodiment, the regulating unit 7 comprises a cooling device 70, which makes it possible to modify the temperature of the coolant liquid L of the exchanger 40, at least one temperature sensor C4 delivering a measurement signal S4 measuring the temperature of the coolant liquid L in the bath 401 of the enclosure 400 of the exchanger 40, an electronic processing unit 71 suitable for automatically controlling the cooling device 70 from the temperature measurement signal S4 and from at least one of the humidity measurement signals S1, S2, S3.

The electronic processing unit 71 can be a programmable electronic processing unit, for example of the programmable automaton type, which is programmed to perform the automatic regulation of the temperature of the coolant liquid L.

More particularly, the electronic processing unit 71 can be designed, and in particular programmed, to automatically calculate at least one variable setpoint temperature Tₛₑₜ from at least one of the humidity measurement signals S1, S2, S3 by means of a predefined function f [Tₛₑₜ=f(S1) or Tₛₑₜ=f(S2) or Tₛₑₜ=f(S3), or Tₛₑₜ=F(S1; S2) or Tₛₑₜ=f(S1; S3) or Tₛₑₜ=f(S2; S3) or Tₛₑₜ=f(S1; S2; S3)], and to automatically control the cooling device 70, such that, when the combustion system is in stabilized operation (steady state), the temperature measured by the signal S4 is substantially equal to the setpoint temperature Tₛₑₜ.

The electronic processing unit 71 can also be designed, and in particular programmed, to automatically calculate a variable setpoint temperature range (Tₘᵢₙ; Tₘₐₓ), from at least one of the humidity measurement signals S1, S2, S3 by means of a predefined function f, and to automatically control the cooling device 70 such that, when the combustion system is in stabilized operation (steady state), the temperature measured by the signal S4 is kept within the setpoint temperature range (Tₘᵢₙ; Tₘₐₓ).

More particularly and in a non-limiting manner, in the particular alternative embodiment of FIG. 2, the cooling device 70 comprises an exchanger 701, for example of the plate exchanger type, comprising a first loop 701a, in which the coolant liquid L can be circulated in a closed manner by means of a pump 701b and a second loop 701c, in which a heat transfer fluid can be circulated in a closed manner by means of a pump 701d, a means 702 for cooling the heat transfer fluid being further provided on the second loop 701c. This heat transfer fluid circulating in the second loop 701c makes it possible to cool the coolant liquid L circulating in the first loop by a contactless heat exchange between the two liquids.

In operation, the bath 401 of coolant liquid L takes calories from the combustion fumes F, during their passage through the bath 401 of liquid, which contributes to causing the temperature of the bath 401d of liquid L to rise. The electronic processing unit 71 automatically controls the pumps 701b and 701d individually, by means of the control signals SC1 and SC2, respectively, according to the above-mentioned setpoint temperature Tₛₑₜ or the above-mentioned setpoint temperature range (Tₘᵢₙ; Tₘₐₓ), and the temperature measured in the liquid bath L (signal S4), so as to sufficiently cool the coolant liquid L and keep the temperature measured by the signal S4 at a value substantially equal to the setpoint temperature Tₛₑₜ or keep the temperature measured by the signal S4 within the setpoint temperature range (Tₘᵢₙ; Tₘₐₓ).

In a simpler alternative embodiment, the setpoint temperature Tₛₑₜ or the setpoint temperature range (Tₘᵢₙ; Tₘₐₓ) can be predefined on a case-by-case basis by being adapted to the combustion apparatus and input as a parameter in the regulating unit 7. In this case, the humidity sensor(s) C1, C2 and C3 are not necessary.

Referring to FIG. 1, the non-recycled portion GDNR of the dehumidified gas GD is treated by at least one CO₂ capture unit 10, which makes it possible, in a manner known per se, to capture the CO₂ by removing all water and molecular oxygen contained in the non-recycled portion GDNR of the dehumidified gas GD. The captured molecular oxygen can also be injected into the unit 3 for producing oxidizing gas GC, in order to reduce the consumption of molecular oxygen supplied by the unit 6.

When the non-recycled portion GDNR of the dehumidified gas GD is free of pollutants, the CO₂ capture operation is easier compared to CO₂ capture in a gas containing pollutants such as SOx, NOx, acids, etc.

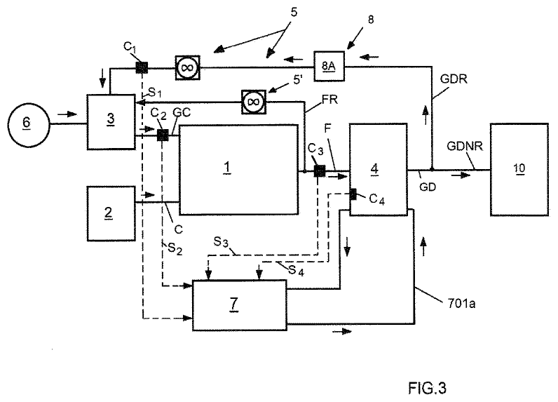

FIG. 3 shows a second variant of a combustion system that differs from the combustion system of FIG. 1 in that the apparatus comprises recycling means 5′, which make it possible to recycle a portion FR of the combustion fumes F at the inlet of the unit 3 for producing oxidizing gas GC, upstream of the condensing unit 4, that is to say a portion FR of the combustion fumes F which have not been dehumidified in the condensing unit 4.

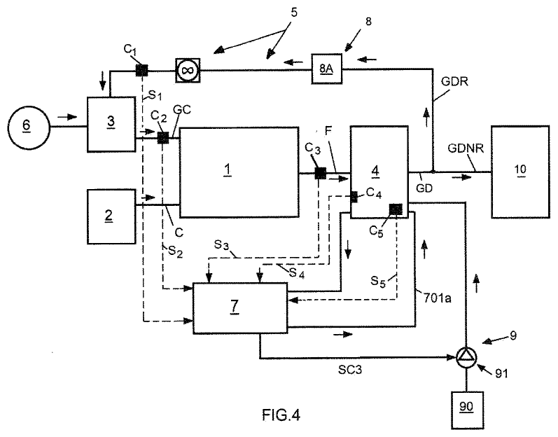

FIG. 4 shows a third variant of a combustion system, which can be used to operate, not only with a fuel C producing combustion fumes F which consist only of carbon dioxide (CO₂) and water (H₂O), and optionally molecular oxygen, but which is also suitable for operating with a fuel C producing combustion fumes F which comprise carbon dioxide (CO₂), water (H₂O), optionally molecular oxygen as well as various pollutants in a greater or lesser concentration, such as, for example and non-exhaustively, SOx (sulfur oxides) and/or NOx (nitrogen oxides) and/or acids of the HCl (hydrogen chloride) and/or HF (hydrogen fluoride) type, and/or ammonia and/or fine particles and/or heavy metals, etc. This fuel C is for example obtained from biomass or solid recovered fuel.

The presence of these pollutants in combustion fumes F complicates the capture of CO₂ compared to combustion fumes consisting solely of carbon dioxide (CO₂) and water (H₂O).

Referring to FIG. 4, the combustion system differs from that of FIG. 1 in that it additionally comprises a supply device 9, comprising a tank 90, which contains at least one treatment additive or a mixture of several different treatment additives, and which is connected to the condensing unit 4, via a supply pump 91 or equivalent, controlled by the regulating unit 7, and for example by the aforementioned electronic processing unit 71, by means of a control signal SC3.

This device 9 makes it possible, in operation, to add one or more treatment additives into the coolant liquid L of the condensing unit 4, in a manner controlled by the regulating unit 7.

A treatment additive can be in different forms, in particular in the form of liquid, dry powder or solution, and is adapted to the type(s) of pollutant(s) potentially contained in the combustion fumes F.

A treatment additive is chosen so as to be able to react in contact with at least one type of pollutant contained in the coolant liquid L of the condensing unit 4, so as to neutralize said pollutant.

As non-limiting and non-exhaustive examples, when the combustion fumes F potentially contain acid pollutants such as SOx (sulfur oxides), acids of the HCl (hydrogen chloride) and/or HF (hydrogen fluoride) type, etc., the treatment additive may be a base such as in particular NaOH, KOH, or may be calcium hydroxide Ca(OH)₂.

When the combustion fumes F potentially contain pollutants of NOx type (nitrogen oxides), the treatment additive may also be a base such as in particular NaOH, KOH, or may be calcium hydroxide Ca(OH)₂ or hydrogen peroxide (H₂O₂).

When the combustion fumes F potentially contain pollutants, such as ammonia, which in a solution produce a solution having a basic pH, such as an aqueous ammonia solution (NH₄OH), the treatment additive may also be an acid, such as for example sulfuric acid (H₂SO₄).

When the combustion fumes F potentially contain VOCs (Volatile Organic Compounds), the treatment additive may be a flocculating agent.

Preferably, the combustion system comprises at least one sensor C5 (FIG. 4), which delivers a measurement signal S5 measuring the pH of the coolant liquid L or the concentration of at least one type of polluting agent in the coolant liquid L.

The regulating unit 7 is designed so as to automatically control the pump 91, by means of the control signal SC3, so as to automatically regulate the addition of treatment additive(s) into the coolant liquid L, depending on the pH or the concentration of treatment additive(s) measured by the sensor C5, such that, for example, the pH of the coolant liquid L is closest to 7, or such that, for example, the concentration of treatment additive(s) in the coolant liquid L is as low as possible and in particular less than a predefined maximum threshold.

In operation, when the combustion fumes F contain various pollutants in a greater or lesser concentration, such as, for example and in a non-exhaustive manner, SOx (sulfur oxides) and/or NOx (nitrogen oxides) and/or acids of the HCl (hydrogen chloride) and/or HF (hydrogen fluoride) type, and/or ammonia and/or fine particles and/or heavy metals, etc., during their time in contact with the coolant liquid L in the condensing unit 4, and in particular when they pass through the bath 401 of coolant liquid L of the condensing unit 4 shown in FIG. 2, the pollutant(s) are advantageously captured and are preferably neutralized in the coolant liquid L if appropriate, which makes it possible to obtain at the outlet of the condensing unit 4 a dehumidified gas (GD) which has had at least some of its pollution sufficiently removed. This avoids recycling an excessively large amount of pollutants at the inlet of the unit 3 for producing oxidizing gas GC.

In another variant, it is also possible to use a plurality of supply devices 9 containing different treatment additives and controlled in parallel by the regulating unit 7.

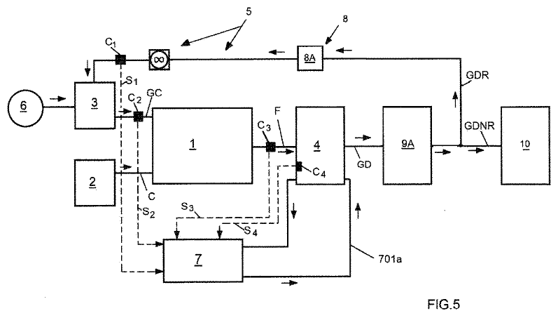

FIG. 5 shows a fourth variant of a combustion system, which differs from that of FIG. 1, in that it further comprises a pollution-removing unit 9A, which in this alternative embodiment is positioned between the condensing unit 4 and the recycling point of the portion GDR of dehumidified gas GD.

The function of this pollution-removing unit 9A is to remove at least some, and preferably a sufficient amount, of the pollutant(s) contained in the dehumidified gas GD obtained at the outlet of the condensing unit 4, so as to recycle, as far as the inlet of the oxidizing gas production unit 3, a portion GDR of dehumidified gas which has had at least some of its pollution removed, and preferably has had a sufficient amount of its pollution removed, and which mainly consists of CO₂, of H₂O in the form of water vapor, and optionally of molecular oxygen.

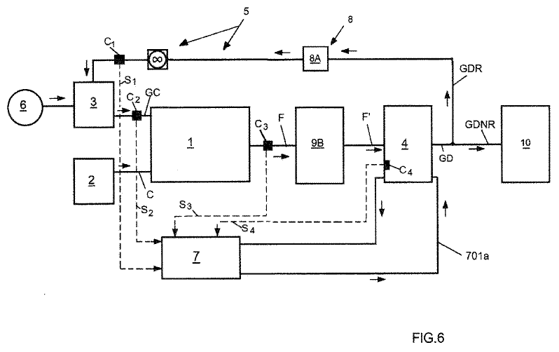

FIG. 6 shows a fifth variant of a combustion system that differs from that of FIG. 1 in that it further comprises a pollution-removing unit 9B, which in this alternative embodiment is positioned between the combustion apparatus 1 and the condensing unit 4. The function of this pollution-removing unit 9B is to remove at least some, and preferably all, of the pollutant(s) contained in the combustion fumes F, before they pass through the condensing unit 4, so as to introduce combustion fumes F′ at the inlet of the condensing unit 4 which have had at least some of their pollution removed, and preferably have had a sufficient amount of their pollution removed, and which mainly consist of CO₂ and of H₂O in the form of water vapor, and optionally of molecular oxygen.

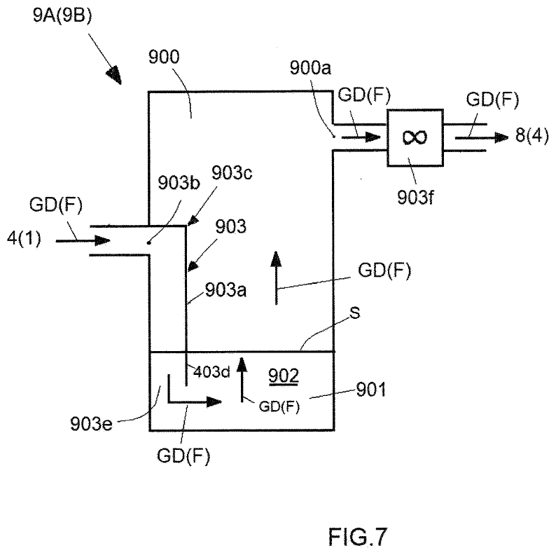

FIG. 7 shows a particular example embodiment of a pollution-removing unit 9A (or 9B).

In this particular embodiment, the pollution-removing unit 9A or 9B comprises a washing device 90, which may generally consist of any type of exchanger making it possible to bring into contact, by any means, the dehumidified gas GD that is to have pollution removed or the combustion fumes F that are to have pollution removed with a washing liquid, so as to capture in the washing liquid at least some of the pollutant(s) contained in the dehumidified gas GD or in the combustion fumes F.

In a preferred alternative embodiment shown in FIG. 7, this washing device 9A (or 9B) is preferably a washing device, of the type comprising an enclosure 900 containing a bath 901 of washing liquid 902 and injection means 903, which are suitable for introducing the dehumidified gas GD that is to have pollution removed or the combustion fumes F that are to have pollution removed below the surface S of the bath 901 of washing liquid 902.

These injection means 903 may more particularly comprise a fan or compressor 903f and a duct 903a comprising an intake opening 903b, for example in its upper part 903c. The lower part 903d of the injection duct 903a is immersed in the bath 901 of washing liquid 902 and comprises a discharge opening 903e immersed in the bath 901 of washing liquid 902.

In operation, the fan or compressor 403f makes it possible to suck in and introduce into the injection duct 903, via the intake opening 903b, the dehumidified gas GD that is to have pollution removed at the outlet of the condensing unit 4 or the combustion fumes F that are to have pollution removed at the outlet of the combustion apparatus 1. The dehumidified gas GD that is to have pollution removed (or combustion fumes F) escapes from the injection duct 903 via the discharge opening 903e, and is therefore introduced forcibly into the bath 901 of washing liquid 902, below the surface S of the bath 901 of washing liquid 902, rises to the surface S of the liquid bath, escape from the enclosure 900 via the discharge opening 900a of the enclosure 400 in the form of a dehumidified gas GD that has had pollution removed (or combustion fumes F that have had pollution removed).

In another variant, the fan or compressor 903f can be connected to the injection duct 903 and used to introduce the dehumidified gas GD that is to have pollution removed or the combustion fumes F that are to have pollution removed by blowing them through the intake opening 903b of this injection duct 903.

When passing through the washing device 90, the pollutant(s) are captured in the bath 901 of washing liquid 902.

The bath 901 of washing liquid 902 may be the same during the entire treatment or can be renewed automatically, during the treatment, with non-polluted washing liquid in order to keep a low concentration of pollutant(s) captured in the bath 901 of washing liquid 902.

The washing liquid 902 may be water or an aqueous solution.

The washing liquid 902 may also contain one or more treatment additives and can be equipped with at least one device for supplying treatment additive(s), as previously described for the variant of FIG. 4.

In another alternative embodiment, the pollution-removing unit 9A (or 9B) may comprise a plurality of washing devices 9A (or 9B) mounted one after another.

In another alternative embodiment, the pollution-removing unit 9A or 9B may be designed to implement a dry pollution removal treatment.

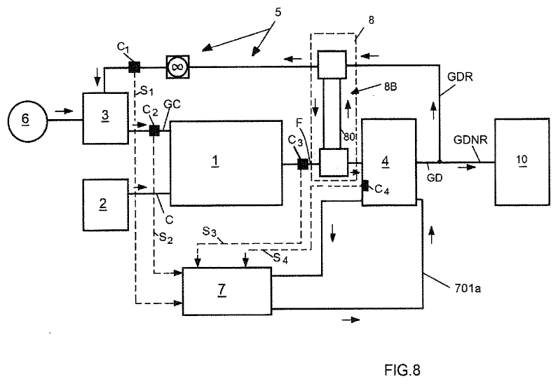

FIG. 8 shows an alternative embodiment of a combustion apparatus that differs from that of FIG. 1 in that the heating means 8 comprises a heat recuperator 8B, of the gas/gas exchanger type, comprising an enthalpy loop 80 in which a heat transfer fluid circulates. This heat recuperator 8B makes it possible to take at least some of the calories from the combustion fumes F and to transfer them to the recycled portion GDR of the dehumidified gas GD, in order to obtain the desired temperature rise for the recycled portion GDR of the dehumidified gas GD, before it is introduced into the unit 3 for producing oxidizing gas GC.

This heating means 8 comprising heat recuperator 8B can also be used in addition to or instead of the heating means 8 described above for the variants of FIGS. 1, 3, 4, 5 and 6.

In the context of the disclosure, the heating means 8 of FIGS. 1, 3, 4, 5, 6 and 8 may however be optional, with the combustion apparatus potentially not comprising them.

In another variant of the disclosure, the combustion apparatus may also comprise such a heating means 8 and have no automatic regulation of the temperature of the coolant liquid L.

Preferably, however, the combustion apparatus comprises both the regulating unit 7 and the heating means 8.

An exemplary aspect of the present disclosure proposes a combustion system comprising a combustion apparatus, which allows for combustion of a fuel by means of an oxidizer obtained by mixing molecular oxygen (O₂) and a gas obtained from at least a portion of combustion fumes, and which allows for better control of the quality of the oxidizing gas used in the combustion apparatus.

Although the present disclosure has been described with reference to one or more examples, workers skilled in the art will recognize that changes may be made in form and detail without departing from the scope of the disclosure and/or the appended claims.

Please amend the presently pending claims as follows:

1. A combustion system comprising:
a unit for producing oxidizing gas,
a combustion apparatus allowing for combustion of a fuel by using said oxidizing gas,
a condensing unit suitable for condensing the combustion fumes produced by the combustion apparatus, by bringing the combustion fumes into contact with at least one coolant liquid, so as to produce a dehumidified gas,
a recycler for supplying the oxidizing gas production unit with at least one recycled portion of the dehumidified gas at an outlet of the condensing unit,
a unit for providing molecular oxygen and for supplying molecular oxygen to the oxidizing gas production unit, the oxidizing gas production unit supplying the combustion apparatus with an oxidizing gas originating from mixing of molecular oxygen and the recycled portion of said dehumidified gas,
a regulating unit, which has a function of automatically regulating a temperature of the coolant liquid of the condensing unit,
and at least one of the following technical features and/or:
(a) at least one sensor for measuring an absolute or relative humidity in the recycled portion of the dehumidified gas and/or at least one sensor for measuring an absolute or relative humidity in the oxidizing gas and/or at least one sensor for measuring an absolute or relative humidity in the combustion fumes, and the regulating unit has a function of automatically regulating the temperature of the coolant liquid of the condensing unit-based at least on the absolute or relative humidity measured in the recycled portion of the dehumidified gas and/or based at least on the absolute or relative humidity measured in the oxidizing gas and/or based at least on the absolute or relative humidity measured in the combustion fumes;
and/or
(b) an operating range defining a maximum absolute or relative humidity and a minimum absolute or relative humidity, and the regulating unit has a function of automatically regulating the temperature of the coolant liquid of the condensing unit so as to keep the absolute or relative humidity of the oxidizing gas within said operating range of the combustion apparatus.

2. The combustion system according to claim 1, comprising a heater for heating the recycled portion of said dehumidified gas.

3. The combustion system according to claim 1, wherein the regulating unit has a function of automatically regulating the temperature of the coolant liquid of the condensing unit so as to keep the absolute or relative humidity of the recycled portion of the dehumidified gas GD-within a predefined operating range.

4. The combustion system according to claim 1, wherein the regulating unit has a function of automatically regulating the temperature of the coolant liquid of the condensing unit so as to keep the absolute or relative humidity of the oxidizing gas within a predefined operating range.

5. The combustion system according to claim 1, wherein the regulating unit has a function of automatically regulating the temperature of the coolant liquid of the condensing unit so as to keep the absolute or relative humidity of the combustion fumes within a predefined operating range.

6. The combustion system according to claim 1, wherein the regulating unit has a function of automatically regulating the temperature of the coolant liquid of the condensing unit so as to keep the temperature of the coolant liquid of the condensing unit at a predefined temperature or within a within a predefined temperature range.

7. The combustion system according to claim 2, wherein the heater is suitable for heating the recycled portion of said dehumidified gas by using of calories taken from the combustion fumes.

8. The combustion system according to claim 1, comprising a heater that is suitable for heating the recycled portion of said dehumidified gas, such that the temperature of the oxidizing gas at an inlet of the combustion apparatus is within a predefined temperature range and/or such that the temperature of the oxidizing gas at the inlet of the combustion apparatus is above the dew point of the oxidizing gas.

9. The combustion system according to claim 1, wherein the condensing unit comprises at least one condensing device comprising a bath of coolant liquid, and an injector making it possible to move the combustion fumes through this bath of coolant liquid.

10. The combustion system according to claim 1, comprising a supply device suitable for introducing one or more treatment additives into the coolant liquid, in order to treat the pollutant(s) potentially captured in the coolant liquid.

11. The combustion system according to claim 1, comprising at least one sensor to measure pH of the coolant liquid or measure concentration of at least one pollutant in the coolant liquid, and a supply device suitable for automatically introducing one or more treatment additives into the coolant liquid, depending on the measured pH or the measured concentration.

12. The system according to claim 10, wherein said at least one treatment additive is a base, and more particularly NaOH, KOH, Ca(OH)₂, or is an acid and more particularly sulfuric acid, or is hydrogen peroxide, or is a flocculating agent.

13. The combustion system according to claim 1, comprising a pollution-removing unit which is positioned between the condensing unit and the recycling point of the recycled portion (GDR) of the dehumidified gas, and which has a function of removing at least some of the pollutant(s) contained in the dehumidified gas obtained at the outlet of the condensing unit, so as to recycle, as far as an inlet of the oxidizing gas production unit, a recycled portion of dehumidified gas that has had at least some of its pollution removed.

14. The combustion system according to claim 1, comprising a pollution-removing unit which is positioned between the combustion apparatus and the condensing unit, and which has a function of removing at least some of the pollutant(s) contained in the combustion fumes, before the pollutant(s) pass through the condensing unit, so as to introduce the combustion fumes into an inlet of the condensing unit with at least some of their pollution removed.

15. The combustion system according to claim 13, comprising a pollution-removing unit is suitable for capturing one or more pollutants selected from the following list: fine particles, SOx, NOx, acids, heavy metals, ammonia, VOCs.

16. The combustion system according to claim 1, comprising a pollution-removing unit comprising at least one washing device suitable for bringing the dehumidified gas that is to have pollution removed or the combustion fumes that are to have pollution removed into contact with a washing liquid.

17. The combustion system according to claim 16, wherein the washing device comprises a bath of washing liquid, and an injector making it possible to move the dehumidified gas that is to have pollution removed or the combustion fumes that are to have pollution removed through this bath of washing liquid.

18. The combustion system according to claim 1, comprising a unit for capturing carbon dioxide (CO₂) from the non-recycled portion of the dehumidified gas.

19. A method comprising:
combusting a fuel by combustion system comprising:
a unit for producing oxidizing gas,
a combustion apparatus allowing for combustion of a fuel by using said oxidizing gas,
a condensing unit suitable for condensing the combustion fumes produced by the combustion apparatus, by bringing the combustion fumes into contact with at least one coolant liquid, so as to produce a dehumidified gas,
a recycler for supplying the oxidizing gas production unit with at least one recycled portion of the dehumidified gas at an outlet of the condensing unit,
a unit for providing molecular oxygen and for supplying molecular oxygen to the oxidizing gas production unit, the oxidizing gas production unit supplying the combustion apparatus with an oxidizing gas originating from mixing of molecular oxygen and the recycled portion of said dehumidified gas,
a regulating unit, which has a function of automatically regulating a temperature of the coolant liquid of the condensing unit,
and at least one of the following technical features (a) and/or (b):
(a) at least one sensor for measuring an absolute or relative humidity in the recycled portion of the dehumidified gas and/or at least one sensor for measuring an absolute or relative humidity in the oxidizing gas and/or at least one sensor for measuring an absolute or relative humidity in the combustion fumes, and the regulating unit has a function of automatically regulating the temperature of the coolant liquid of the condensing unit based at least on the absolute or relative humidity measured in the recycled portion of the dehumidified gas and/or based at least on the absolute or relative humidity measured in the oxidizing gas and/or based at least on the absolute or relative humidity measured in the combustion fumes;
and/or
(b) an operating range defining a maximum absolute or relative humidity and a minimum absolute or relative humidity, and the regulating unit has a function of automatically regulating the temperature of the coolant liquid of the condensing unit so as to keep the absolute or relative humidity of the oxidizing gas within said operating range of the combustion apparatus,
and the method comprising:
supplying the combustion unit with the fuel and with the oxidizing gas originating from the mixing of the molecular oxygen and the recycled portion of the dehumidified gas obtained from the combustion fumes.

20. The method according to claim 19, comprising automatically regulating the temperature of the coolant liquid.

21. The method according to claim 19, comprising heating the recycled portion of the dehumidified gas before the dehumidified gas is introduced into the unit for producing oxidizing gas.

22. The method according to claim 21, comprising taking calories from the combustion fumes and using the calories to heat the recycled portion of the dehumidified gas before the dehumidified gas is introduced into the unit for producing oxidizing gas.

23. The method according to claim 21, wherein the recycled portion of said dehumidified gas is heated such that the temperature of the oxidizing gas at an inlet of the combustion apparatus is within a predefined temperature range and/or such that the temperature of the oxidizing gas at the inlet of the combustion apparatus is above the dew point of the oxidizing gas.

24. The method according to claim 19, wherein the fuel is chosen so as to produce, at an outlet of the combustion apparatus, combustion fumes which comprise carbon dioxide and water vapor.

25. The method according to claim 24, wherein the fuel is a hydrocarbon.

26. The method according to claim 19, wherein the combustion fumes produced at an outlet of the combustion apparatus comprise carbon dioxide, water vapor, and one or more pollutants, and more particularly one or more pollutants selected from the following list: fine particles, SOx, NOx, acids, heavy metals, ammonia, VOCs.

27. The method according to claim 26, wherein the combustion fumes have all or some of their pollution removed as the combustion fumes pass through the condensing unit.

28. The method according to claim 26, wherein the combustion fumes have all or some of their pollution removed before the combustion fumes pass through the condensing unit.

29. The method according to claim 26, wherein the dehumidified gas has all or some of its pollution removed before a portion of this dehumidified gas is recycled at an inlet of the oxidizing gas production unit.

30. The method according to claim 19, wherein the carbon dioxide is captured from the non-recycled portion of the dehumidified gas.
